(19) United States
(12) Patent Application Publication
(10) Pub. No.: US 2024/0162991 A1
(43) Pub. Date: May 16, 2024

(54) OPTICAL TRANSMITTING APPARATUS AND OPTICAL TRANSMITTING METHOD

(71) Applicant: NIPPON TELEGRAPH AND TELEPHONE CORPORATION, Tokyo (JP)

(72) Inventors: Ryo MIYATAKE, Musashino-shi, Tokyo (JP); Yoichi FUKADA, Musashino-shi, Tokyo (JP); Toshiaki SHITABA, Musashino-shi, Tokyo (JP); Akihiro TANABE, Musashino-shi, Tokyo (JP); Tomoaki YOSHIDA, Musashino-shi, Tokyo (JP)

(73) Assignee: NIPPON TELEGRAPH AND TELEPHONE CORPORATION, Tokyo (JP)

(21) Appl. No.: 18/281,773

(22) PCT Filed: Apr. 1, 2021
(86) PCT No.: PCT/JP2021/014175

§ 371 Date: Sep. 12, 2023

(51) Int. Cl. H04B 10/516; H04B 10/50; H04J 14/00

(52) U.S. Cl. CPC H04B 10/5161; H04B 10/503; H04J 14/00

(57) ABSTRACT

An optical transmission device includes: a first optical phase modulator that outputs a first optical signal by phase-modulating the laser beam having a first oscillation frequency according to the first electric signal in a case where the first electric signal is output to the first transmission path, a second optical phase modulator that outputs a laser beam having a second oscillation frequency as the second optical signal in a case where the first electric signal is output to the first transmission path; an optical multiplexer/distributor that outputs a third optical signal and a fourth optical signal by multiplexing the first optical signal and the second optical signal and distributing a result of the multiplexing; a first detection unit that converts the third optical signal into a first heterodyne detection signal; a second detection unit that converts the fourth optical signal into a second heterodyne detection signal; and a first optical intensity modulator that intensity-modulates a laser beam having a third oscillation frequency according to one of the first heterodyne detection signal and the second heterodyne detection signal.

### TECHNICAL FIELD

The present invention relates to an optical transmission device and an optical transmission method.

### BACKGROUND ART

As a network system that distributes video data to subscriber's homes, a fiber to the home (FTTH) cable television (CATV) system is known. In an FTTH CATV system, a frequency modulation (FM) batch conversion system may be used as an optical transmission system (refer to Non Patent Literature 1). Hereinafter, frequency modulation batch conversion is referred to as “FM batch conversion.” An FTTH CATV system includes an optical transmission device.

FIG. 13 is a diagram illustrating a configuration example of two optical transmission devices 10 with redundant signal systems. An optical transmission device 10-1 (current system) and an optical transmission device 10-2 (reserve system) have the same configuration. The optical transmission device 10 includes an input terminal 11, a first laser oscillator 12, a second laser oscillator 13, an optical phase modulator 14, an optical multiplexer/distributor 15, a detection unit 16, a third laser oscillator 17, an optical intensity modulator 18, and an output terminal 19.

An electric signal of frequency-multiplexed multi-channel video is input to a switching unit 20-1 from a head end device 2. In a case where the optical transmission device 10-1 does not fail, the switching unit 20-1 outputs the electric signal input from the head end device 2 to the optical transmission device 10-1. In a case where the optical transmission device 10-1 fails, the switching unit 20-1 outputs the electric signal input from the head end device 2 to the optical transmission device 10-2.

The electric signal of frequency-multiplexed multi-channel video is input to the input terminal 11 from the switching unit 20-1. The input terminal 31 outputs the electric signal of frequency-multiplexed multi-channel video to the optical phase modulator 14. The first laser oscillator 12 outputs a laser beam having a first oscillation frequency to the optical phase modulator 14 using a laser diode. The second laser oscillator 13 outputs a laser beam having a second oscillation frequency to the optical multiplexer/distributor 15 using a laser diode. The first oscillation frequency and the second oscillation frequency are different from each other.

The optical phase modulator 14 phase-modulates the laser beam having a first oscillation frequency according to the electric signal input from the input terminal 11. The optical phase modulator 14 outputs an optical signal, which is a result of phase modulation of the laser beam having a first oscillation frequency, to the optical multiplexer/distributor 15. The optical multiplexer/distributor 15 multiplexes an optical signal, which is a result of phase modulation of the laser beam having a first oscillation frequency, and the laser beam having a second oscillation frequency. The optical multiplexer/distributor 15 outputs an optical signal, which is a result of multiplexing, to the detection unit 16 from one output port of the two output ports.

The detection unit 16 converts an optical signal, which is a result of multiplexing, into a heterodyne detection signal using a photodiode. The detection unit 16 outputs the heterodyne detection signal to the optical intensity modulator 18. The third laser oscillator 17 outputs a laser beam having a third oscillation frequency to the optical intensity modulator 18 using a laser diode. The optical intensity modulator 18 intensity-modulates the laser beam having a third oscillation frequency according to the heterodyne detection signal. The output terminal 19 outputs the intensity-modulated laser beam having a third oscillation frequency to the switching unit 20-2 using a relay network 6. The intensity-modulated laser beam having a third oscillation frequency is input to the switching unit 20-2 from the optical transmission device 10-1 or the optical transmission device 10-2.

### CITATION LIST

### Non Patent Literature

Non Patent Literature 1: Toshiaki Shitaba and two others, “FM Ikkatsu Henkan Hōshiki wo mochiita Hikari Eizō Haishin Gijutsu (Optical Video Transmission Technique Using FM Batch Conversion),” The Institute of Electronics, Information and Communication Engineers (IEICE), The Technical Report of The Proceeding of The IEICE, CS2019-84, IE2019-64(2019-12).

### SUMMARY OF INVENTION

### Technical Problem

Conventionally, when a signal system is made redundant, two optical transmission devices are simply connected in parallel. Thus, the number of components is doubled. For example, in FIG. 13, in order to execute heterodyne detection, two optical transmission devices 10 are provided with two first laser oscillators 12, two second laser oscillators 13, and two optical multiplexer/distributors 15. As described above, in a case where an increase in the number of components is suppressed, it may not be possible to make the signal system redundant.

In view of the above circumstances, an object of the present invention is to provide an optical transmission device and an optical transmission method capable of suppressing an increase in the number of components and making a signal system redundant.

### Solution to Problem

According to an aspect of the present invention, there is provided an optical transmission device including: a first laser oscillator that outputs a laser beam having a first oscillation frequency; a second laser oscillator that outputs a laser beam having a second oscillation frequency; a first switching unit that outputs a first electric signal to one of a first transmission path and a second transmission path; a first optical phase modulator that outputs a first optical signal by phase-modulating the laser beam having a first oscillation frequency according to the first electric signal in a case where the first electric signal is output to the first transmission path, and outputs the laser beam having a first oscillation frequency as the first optical signal in a case where the first electric signal is output to the second transmission path; a second optical phase modulator that outputs a second optical signal by phase-modulating the laser beam having a second oscillation frequency according to the first electric signal in a case where the first electric signal is output to the second transmission path, and outputs the laser beam having a second oscillation frequency as the second optical signal in a case where the first electric signal is output to the first transmission path; an optical multiplexer/distributor that outputs a third optical signal and a fourth optical signal by multiplexing the first optical signal and the second optical signal and distributing a result of the multiplexing; a first detection unit that converts the third optical signal into a first heterodyne detection signal; a second detection unit that converts the fourth optical signal into a second heterodyne detection signal; and a first optical intensity modulator that intensity-modulates a laser beam having a third oscillation frequency according to one of the first heterodyne detection signal and the second heterodyne detection signal.

According to another aspect of the present invention, there is provided an optical transmission method executed by an optical transmission device, the method including: a first laser oscillation step of outputting a laser beam having a first oscillation frequency; a second laser oscillation step of outputting a laser beam having a second oscillation frequency; a first switching step of outputting a first electric signal to one of a first transmission path and a second transmission path; a first optical phase modulation step of outputting a first optical signal by phase-modulating the laser beam having a first oscillation frequency according to the first electric signal in a case where the first electric signal is output to the first transmission path, and outputting the laser beam having a first oscillation frequency as the first optical signal in a case where the first electric signal is output to the second transmission path; a second optical phase modulation step of outputting a second optical signal by phase-modulating the laser beam having a second oscillation frequency according to the first electric signal in a case where the first electric signal is output to the second transmission path, and outputting the laser beam having a second oscillation frequency as the second optical signal in a case where the first electric signal is output to the first transmission path; an optical multiplexing/distributing step of outputting a third optical signal and a fourth optical signal by multiplexing the first optical signal and the second optical signal and distributing a result of the multiplexing; a first detection step of converting the third optical signal into a first heterodyne detection signal; a second detection step of converting the fourth optical signal into a second heterodyne detection signal; and a first optical intensity modulation step of intensity-modulating a laser beam having a third oscillation frequency according to one of the first heterodyne detection signal and the second heterodyne detection signal.

### Advantageous Effects of Invention

According to the present invention, it is possible to suppress an increase in the number of components and to make a signal system redundant.

### BRIEF DESCRIPTION OF DRAWINGS

FIG. 1 is a diagram illustrating an example of a network configuration of an FTTH CATV system according to each embodiment.

FIG. 2 is a diagram illustrating a configuration example of an optical transmission device according to a first embodiment.

FIG. 3 is a flowchart illustrating an operation example of the optical transmission device according to the first embodiment.

FIG. 4 is a diagram illustrating a configuration example of an optical transmission device according to a first modification example of the first embodiment.

FIG. 5 is a diagram illustrating a configuration example of an optical transmission device according to a second modification example of the first embodiment.

FIG. 6 is a diagram illustrating a configuration example of an optical transmission device according to a second embodiment.

FIG. 7 is a diagram illustrating a configuration example of an optical transmission device according to a first modification example of the second embodiment.

FIG. 8 is a diagram illustrating a configuration example of an optical transmission device according to a second modification example of the second embodiment.

FIG. 9 is a diagram illustrating a configuration example of an optical transmission device according to a third embodiment.

FIG. 10 is a diagram illustrating a configuration example of an optical transmission device according to a first modification example of the third embodiment.

FIG. 11 is a diagram illustrating a configuration example of an optical transmission device according to a second modification example of the third embodiment.

FIG. 12 is a diagram illustrating a hardware configuration example of the optical transmission device according to each embodiment.

FIG. 13 is a diagram illustrating a configuration example of two optical transmission devices with redundant signal systems.

### DESCRIPTION OF EMBODIMENTS

Embodiments of the present invention will be described in detail with reference to the drawings.

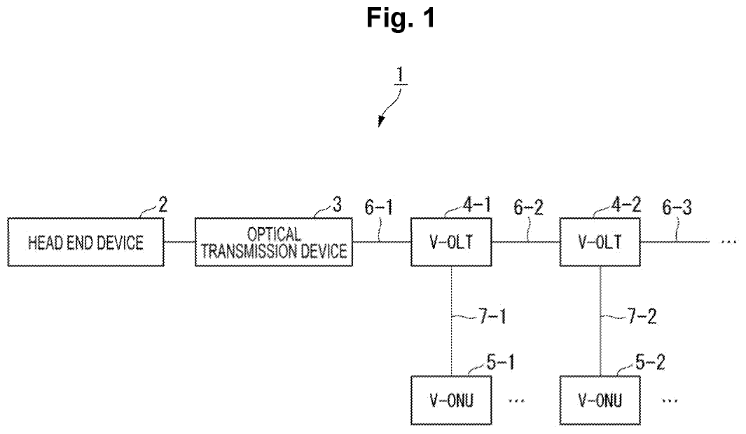

FIG. 1 is a diagram illustrating an example of a network configuration of an FTTH CATV system 1 according to each embodiment. In the FTTH CATV system 1, an FM batch conversion system is used as an optical transmission system. The FTTH CATV system 1 includes a head end device 2, an optical transmission device 3, one or more video-optical line terminals (V-OLT) 4, and one or more video-optical network units (V-ONU) 5.

The FTTH CATV system 1 includes a relay network 6 and an access network 7 as optical transmission paths. The optical transmission device 3 and the V-OLT 4-1 are connected to be capable of communicating with each other by using a relay network 6-1. The V-OLT 4-n (n is an integer of 1 or more) and the V-OLT 4-(n+1) are connected to be capable of communicating with each other by using a relay network 6-(n+1). The V-OLT 4-n and the V-ONU 5-n are connected to be capable of communicating with each other by using an access network 7-n.

The head end device 2 receives radio waves representing a video signal transmitted from a broadcasting station (not illustrated) via a transmission tower, an artificial satellite, or the like (not illustrated). The head end device 2 executes adjustment processing such as amplification on the received radio waves. The head end device 2 outputs the electric signal of frequency-multiplexed multi-channel video to the optical transmission device 3 as an electric signal corresponding to the video signal.

The optical transmission device 3 acquires electric signals of frequency-multiplexed multi-channel video from the head end device 2 for each band. The optical transmission device 3 converts the acquired electric signal into an optical signal. The optical transmission device 3 batch converts the electric signals of frequency-multiplexed multi-channel video into one-channel broadband frequency modulation (FM) signals. The optical transmission device 3 converts the one-channel broadband frequency modulation signal into an intensity-modulated optical signal. The optical transmission device 3 outputs the intensity-modulated optical signal to the optical transmission path.

The V-OLT 4 is a station-side video distribution device (optical subscriber line terminal device). The V-OLT 4 functions as an amplifier (repeater) of an optical signal. The V-OLT 4 transmits the optical signal of which the intensity has been amplified to the V-ONU 5 of the access network 7. The V-OLT 4 may branch the intensity-amplified optical signal using an optical coupler. The V-OLT 4 may relay the amplified optical signal to the V-ONU 5 connected to the access network 7 and another V-OLT 4 at the subsequent stage.

The V-ONU 5 is an optical reception device such as a home video reception device (optical line termination device). The V-ONU 5 receives an optical signal from the V-OLT 4 via the access network 7. The V-ONU 5 converts the received optical signal into a frequency modulation signal (electric signal). The V-ONU 5 executes demodulation processing on the frequency modulation signal. Thereby, the V-ONU 5 can extract electric signals of frequency-multiplexed multi-channel video from the optical signal.

The relay network 6 is a communication network that relays an optical signal between the optical transmission device 3 and the access network 7. The access network 7 is a communication network that connects the relay network 6 and each of the optical reception devices 400 that terminate an optical signal. The access network 7 is, for example, a passive optical network (PON). The access network 7-n may include an amplifier. The access network 7-n distributes an optical signal output from the relay network 6-n to one or more V-ONUs 5-n.

Next, a configuration example of the optical transmission device will be described.

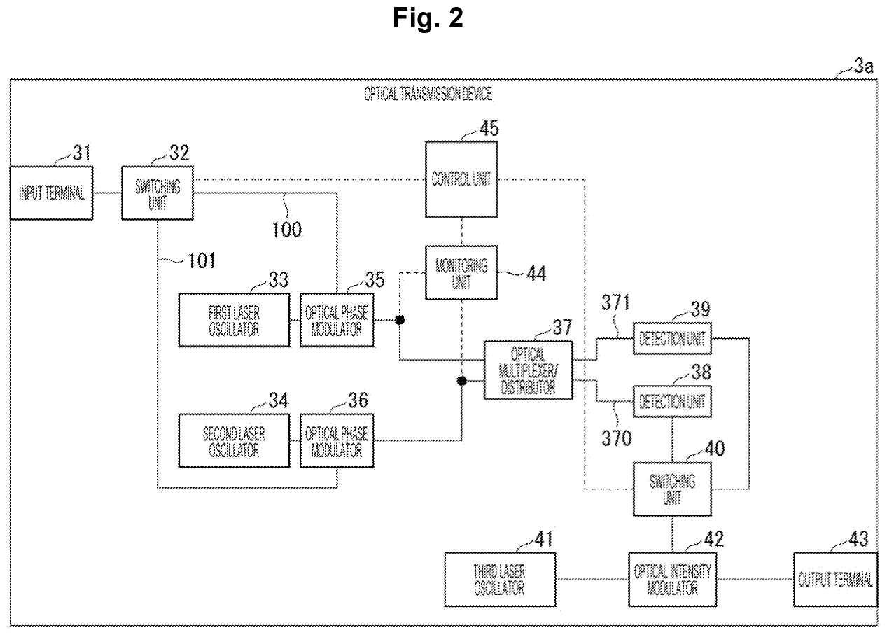

FIG. 2 is a diagram illustrating a configuration example of an optical transmission device 3a. The optical transmission device 3a corresponds to the optical transmission device 3 illustrated in FIG. 1. The optical transmission device 3a includes an input terminal 31, a switching unit 32, a first laser oscillator 33, a second laser oscillator 34, an optical phase modulator 35, an optical phase modulator 36, an optical multiplexer/distributor 37, a detection unit 38, a detection unit 39, a switching unit 40, a third laser oscillator 41, an optical intensity modulator 42, an output terminal 43, a monitoring unit 44, and a control unit 45.

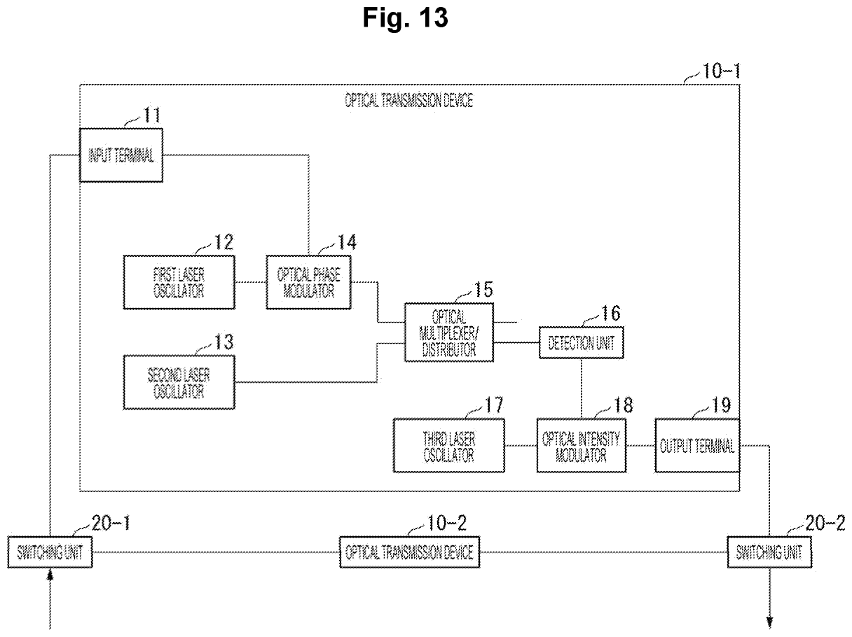

As described above, as compared with the signal system in the optical transmission device 10 illustrated in FIG. 13, the switching unit 32, the optical phase modulator 36, the detection unit 39, and the switching unit 40 are added to the signal system in the optical transmission device 3a.

The switching unit 32 includes a first transmission path 100 and a second transmission path 101. The switching unit 32 and the optical phase modulator 35 are connected via the first transmission path 100. The switching unit 32 and the optical phase modulator 36 are connected via the second transmission path 101.

The optical multiplexer/distributor 37 (1:1 coupler) includes a first output port 370 and a second output port 371. The optical multiplexer/distributor 37 and the detection unit 38 are connected via the first output port 370. The optical multiplexer/distributor 37 and the detection unit 39 are connected via the second output port 371.

In the optical transmission device 3a, in a case where one of the optical phase modulator 35 and the optical phase modulator 36 fails, the other is used, and thus redundancy of the signal system can be achieved.

An electric signal of frequency-multiplexed multi-channel video is input to the input terminal 31 from the head end device 2. The input terminal 31 outputs the electric signal to the switching unit 32. The switching unit 32 outputs an electric signal to one of the first transmission path 100 and the second transmission path 101 under the control of the control unit 45.

The first laser oscillator 33 outputs a laser beam having a first oscillation frequency to the optical phase modulator 35 using a laser diode. The second laser oscillator 34 outputs a laser beam having a second oscillation frequency to the optical phase modulator 36 using a laser diode. The first oscillation frequency and the second oscillation frequency are different from each other.

In a case where the electric signal is output to the first transmission path 100 from the switching unit 32, the optical phase modulator 35 phase-modulates the laser beam having a first oscillation frequency according to the electric signal. The optical phase modulator 35 inputs a first optical signal, which is a result of phase modulation of the laser beam having a first oscillation frequency, to the first input port of the optical multiplexer/distributor 37. In a case where the electric signal is output to the second transmission path 101 from the switching unit 32, the optical phase modulator 35 inputs the laser beam having a first oscillation frequency as the first optical signal to the first input port of the optical multiplexer/distributor 37.

In a case where the electric signal is output to the second transmission path 101 from the switching unit 32, the optical phase modulator 36 phase-modulates the laser beam having a second oscillation frequency according to the electric signal. The optical phase modulator 36 inputs a second optical signal, which is the result of phase modulation of the laser beam having a second oscillation frequency, to the second input port of the optical multiplexer/distributor 37. In a case where the electric signal is output to the first transmission path 100 from the switching unit 32, the optical phase modulator 36 inputs the laser beam having a second oscillation frequency as the second optical signal to the second input port of the optical multiplexer/distributor 37.

The optical multiplexer/distributor 37 multiplexes the first optical signal and the second optical signal. The optical multiplexer/distributor 37 outputs the third optical signal, which is the result of multiplexing, from the first output port 370 to the detection unit 38 by distributing the result of multiplexing. The optical multiplexer/distributor 37 outputs the fourth optical signal, which is the result of multiplexing, from the second output port 371 to the detection unit 39 by distributing the result of multiplexing.

The detection unit 38 converts the third optical signal into a first heterodyne detection signal using a photodiode. The detection unit 38 outputs the first heterodyne detection signal to the switching unit 40. The detection unit 39 converts the fourth optical signal into a second heterodyne detection signal using a photodiode. The detection unit 39 outputs the second heterodyne detection signal to the switching unit 40. The switching unit 40 outputs one of the first heterodyne detection signal and the second heterodyne detection signal to the optical intensity modulator 42 under the control of the control unit 45.

The third laser oscillator 41 outputs a laser beam having a predetermined third oscillation frequency to the optical intensity modulator 42 using a laser diode. In a case where the first heterodyne detection signal is output from the switching unit 40, the optical intensity modulator 42 intensity-modulates the laser beam having a third oscillation frequency according to the first heterodyne detection signal. In a case where the second heterodyne detection signal is output from the switching unit 40, the optical intensity modulator 42 intensity-modulates the laser beam having a third oscillation frequency according to the second heterodyne detection signal. The output terminal 43 outputs the intensity-modulated laser beam having a third oscillation frequency to the V-OLT 4-1 using the relay network 6-1.

The monitoring unit 44 determines whether or not a failure has occurred in the optical phase modulator 35 based on whether or not a non-phase-modulated signal is output from the optical phase modulator 35 as the first optical signal. Here, in a case where a non-phase-modulated signal is output as the first optical signal from the optical phase modulator 35 (current system), the monitoring unit 44 determines that a failure has occurred in the optical phase modulator 35. The monitoring unit 44 outputs a determination result related to a failure of the optical phase modulator 35 (current system) to the control unit 45.

The monitoring unit 44 may determine whether or not a failure has occurred in the optical phase modulator 36 based on whether or not a non-phase-modulated signal is output from the optical phase modulator 36 (reserve system) as the second optical signal. Here, in a case where the non-phase-modulated signal is output from the optical phase modulator 36 as the second optical signal, the monitoring unit 44 determines that a failure has occurred in the optical phase modulator 36. The monitoring unit 44 may output the determination result related to the failure of the optical phase modulator 36 (reserve system) to the control unit 45.

In a case where the monitoring unit 44 determines that no failure has occurred in the optical phase modulator 35, the control unit 45 outputs a control signal to the switching unit 32 such that the switching unit 32 outputs an electric signal to the first transmission path 100. In a case where the monitoring unit 44 determines that a failure has occurred in the optical phase modulator 35, the control unit 45 outputs a control signal to the switching unit 32 such that the switching unit 32 outputs an electric signal to the second transmission path 101.

Note that the control unit 45 may control the operation of the switching unit 40. In a case where the monitoring unit 44 determines that no failure has occurred in the optical phase modulator 35 (current system), the control unit 45 may output a control signal to the switching unit 40 such that the switching unit 40 outputs the first heterodyne detection signal of the detection unit 38 (current system) to the optical intensity modulator 42. In a case where the monitoring unit 44 determines that a failure has occurred in the optical phase modulator 35 (current system), the control unit 45 may output a control signal to the switching unit 40 such that the switching unit 40 outputs the second heterodyne detection signal of the detection unit 39 (reserve system) to the optical intensity modulator 42.

In a case where the monitoring unit 44 determines that no failure has occurred in the optical phase modulator 36 (reserve system), the control unit 45 may output a control signal to the switching unit 32 such that the switching unit 32 outputs an electric signal to the second transmission path 101. In a case where the monitoring unit 44 determines that a failure has occurred in the optical phase modulator 36 (reserve system), the control unit 45 may output a control signal to the switching unit 32 such that the switching unit 32 outputs an electric signal to the first transmission path 100.

Note that the control unit 45 may control the operation of the switching unit 40. In a case where the monitoring unit 44 determines that no failure has occurred in the optical phase modulator 36 (reserve system), the control unit 45 may output a control signal to the switching unit 40 such that the switching unit 40 outputs the second heterodyne detection signal of the detection unit 39 (reserve system) to the optical intensity modulator 42. In a case where the monitoring unit 44 determines that a failure has occurred in the optical phase modulator 36 (reserve system), the control unit 45 may output a control signal to the switching unit 40 such that the switching unit 40 outputs the first heterodyne detection signal of the detection unit 38 (current system) to the optical intensity modulator 42.

Next, an operation example of the optical transmission device 3a will be described.

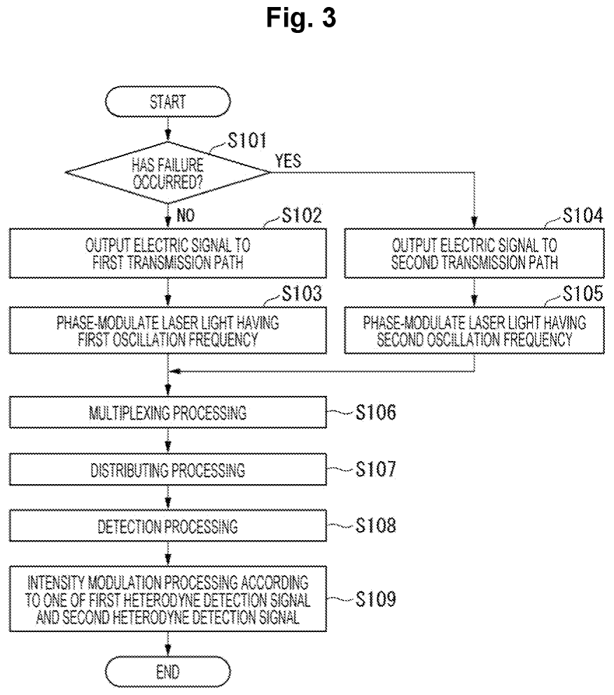

FIG. 3 is a flowchart illustrating an operation example of the optical transmission device 3a. The first laser oscillator 33 outputs a laser beam having a first oscillation frequency. The second laser oscillator 34 outputs a laser beam having a second oscillation frequency. The third laser oscillator 41 outputs a laser beam having a third oscillation frequency. The monitoring unit 44 determines whether or not a failure has occurred in the optical phase modulator 35 (step S101).

In a case where it is determined that no failure has occurred in the optical phase modulator 35 (step S101: NO), the switching unit 32 (first switching unit) outputs the electric signal input to the input terminal 31 to the first transmission path 100 under the control of the control unit 45 (step S102).

The optical phase modulator 35 (first optical phase modulator) outputs the first optical signal to the optical multiplexer/distributor 37 by phase-modulating the laser beam having a first oscillation frequency according to the electric signal. The optical phase modulator 36 (second optical phase modulator) outputs the laser beam having a second oscillation frequency to the optical multiplexer/distributor 37 as a second optical signal (step S103).

In a case where it is determined that a failure has occurred in the optical phase modulator 35 (step S101: YES), the switching unit 32 outputs the electric signal input to the input terminal 31 to the second transmission path 101 under the control of the control unit 45 (step S104).

The optical phase modulator 35 (first optical phase modulator) outputs the laser beam having a first oscillation frequency to the optical multiplexer/distributor 37 as a first optical signal. The optical phase modulator 36 (second optical phase modulator) outputs the second optical signal to the optical multiplexer/distributor 37 by phase-modulating the laser beam having a second oscillation frequency according to the electric signal (step S105).

The optical multiplexer/distributor 37 multiplexes the first optical signal and the second optical signal (step S106). The optical multiplexer/distributor 37 outputs the third optical signal to the detection unit 38 by distributing the result of multiplexing. The optical multiplexer/distributor 37 outputs the fourth optical signal to the detection unit 39 by distributing the result of multiplexing (step S107).

The detection unit 38 (first detection unit) converts the third optical signal into a first heterodyne detection signal. The detection unit 39 (second detection unit) converts the fourth optical signal into a second heterodyne detection signal (step S108). The optical intensity modulator 42 (first optical intensity modulator) intensity-modulates the laser beam having a third oscillation frequency of the third laser oscillator 41 according to one of the first heterodyne detection signal and the second heterodyne detection signal (step S109).

As a result, it is possible to suppress an increase in the number of components and to make the signal system redundant. In the first embodiment, the signal system from the input terminal to the optical phase modulator can be duplicated using the minimum necessary elements.

For example, in FIG. 13, two optical transmission devices 10 are simply connected in parallel such that the signal system is made redundant. The two optical transmission devices 10 illustrated in FIG. 13 include four laser oscillators and two optical multiplexer/distributors 15 (1:1 couplers) for heterodyne detection.

On the other hand, the optical transmission device 3a includes two laser oscillators and one multiplexer/distributor for heterodyne detection. In the first embodiment, the optical transmission device 3a can duplicate the signal system from the input terminal to the optical phase modulator only by adding the minimum necessary elements (the switching unit 32, the optical phase modulator 36, the detection unit 39, and the switching unit 40) to the optical transmission device 3a.

### First Modification Example of First Embodiment

The first modification example of the first embodiment is different from the first embodiment in that the first electric signal and the second electric signal are input to the optical transmission device. In the first modification example of the first embodiment, differences from the first embodiment will be mainly described.

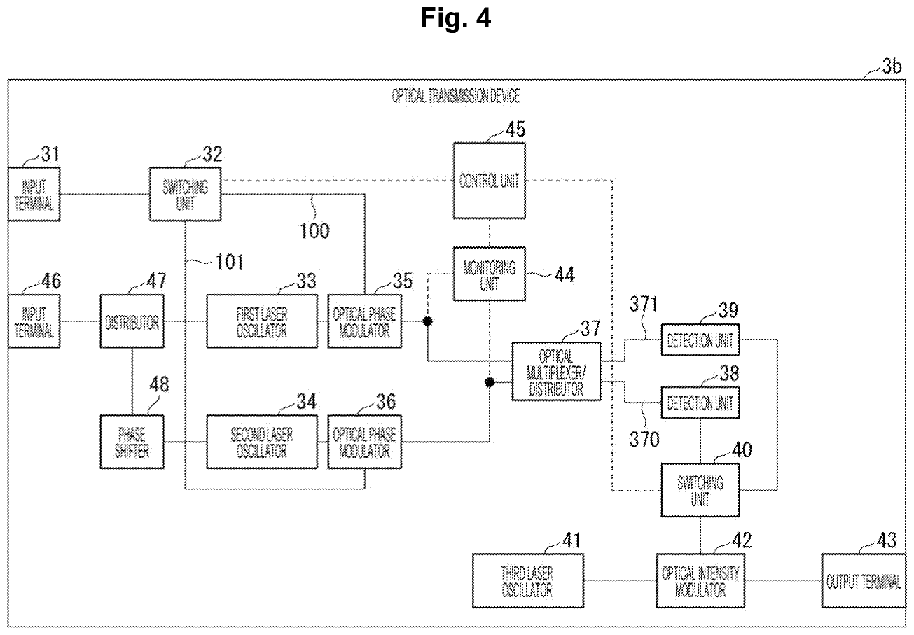

FIG. 4 is a diagram illustrating a configuration example of an optical transmission device 3b. The optical transmission device 3b corresponds to the optical transmission device 3 illustrated in FIG. 1. The optical transmission device 3b includes the input terminal 31, the switching unit 32, the first laser oscillator 33, the second laser oscillator 34, the optical phase modulator 35, the optical phase modulator 36, the optical multiplexer/distributor 37, the detection unit 38, the detection unit 39, the switching unit 40, the third laser oscillator 41, the optical intensity modulator 42, the output terminal 43, the monitoring unit 44, and the control unit 45. In addition, the optical transmission device 3b includes an input terminal 46, a distributor 47, and a phase shifter 48.

As described above, compared with the signal system in the optical transmission device 10 illustrated in FIG. 13, the switching unit 32, the optical phase modulator 36, the detection unit 39, the switching unit 40, the input terminal 46, the distributor 47, and the phase shifter 48 are added to the signal system in the optical transmission device 3b.

The first electric signal (signal with high priority) of frequency-multiplexed multi-channel video is input to the input terminal 31 from the head end device 2. The input terminal 31 outputs the first electric signal to the switching unit 32. In this manner, the input terminal 31 can input the first electric signal to the reserve system. The second electric signal (signal with low priority) of frequency-multiplexed multi-channel video is input to the input terminal 46 from the head end device 2. Here, the frequency of the waveform of the first electric signal and the frequency of the waveform of the second electric signal are different from each other. The input terminal 46 outputs the second electric signal to the distributor 47. The distributor 47 distributes the second electric signal to the first laser oscillator 33 and the phase shifter 48. The phase shifter 48 inverts the phase of the second electric signal.

The first laser oscillator 33 outputs the laser beam having a first oscillation frequency directly modulated according to the second electric signal, to the optical phase modulator 35. The second laser oscillator 34 outputs the laser beam having a second oscillation frequency directly modulated according to the phase-inverted second electric signal, to the optical phase modulator 36.

In a case where the first electric signal is output to the first transmission path 100 from the switching unit 32, the optical phase modulator 35 phase-modulates the laser beam having a first oscillation frequency which is directly modulated according to the second electric signal, according to the first electric signal. The optical phase modulator 35 inputs a first optical signal, which is a result of phase modulation of the laser beam having a first oscillation frequency, to the first input port of the optical multiplexer/distributor 37. In a case where the first electric signal is output to the second transmission path 101 from the switching unit 32, the optical phase modulator 35 inputs the laser beam having a first oscillation frequency, which is directly modulated according to the second electric signal, as the first optical signal to the first input port of the optical multiplexer/distributor 37.

In a case where the first electric signal is output to the second transmission path 101 from the switching unit 32, the optical phase modulator 36 phase-modulates the laser beam having a second oscillation frequency which is directly modulated according to the phase-inverted second electric signal, according to the first electric signal. The optical phase modulator 36 inputs a second optical signal, which is the result of phase modulation of the laser beam having a second oscillation frequency, to the second input port of the optical multiplexer/distributor 37. In a case where the first electric signal is output to the first transmission path 100 from the switching unit 32, the optical phase modulator 36 inputs the laser beam having a second oscillation frequency, which is directly modulated according to the phase-inverted second electric signal, as the second optical signal to the second input port of the optical multiplexer/distributor 37.

As described above, the first laser oscillator 33 directly modulates the laser beam having a first oscillation frequency according to the electric signal (second electric signal) input to the input terminal 46. The first laser oscillator 33 outputs the directly modulated laser beam having a first oscillation frequency to the optical phase modulator 35 (first optical phase modulator). The second laser oscillator 34 directly modulates the laser beam having a second oscillation frequency according to the phase-inverted second electric signal. The second laser oscillator 34 outputs the directly modulated laser beam having a second oscillation frequency to the optical phase modulator 36 (second optical phase modulator).

As a result, it is possible to suppress an increase in the number of components and to make the signal system redundant. In addition, the first electric signal with higher priority than the second electric signal can be transmitted by the redundant signal system.

### Second Modification Example of First Embodiment

The second modification example of the first embodiment is different from the first modification example of the first embodiment in that the transmission path of the first electric signal and the transmission path of the second electric signal can be interchanged. In the second modification example of the first embodiment, differences from the first modification example of the first embodiment will be mainly described.

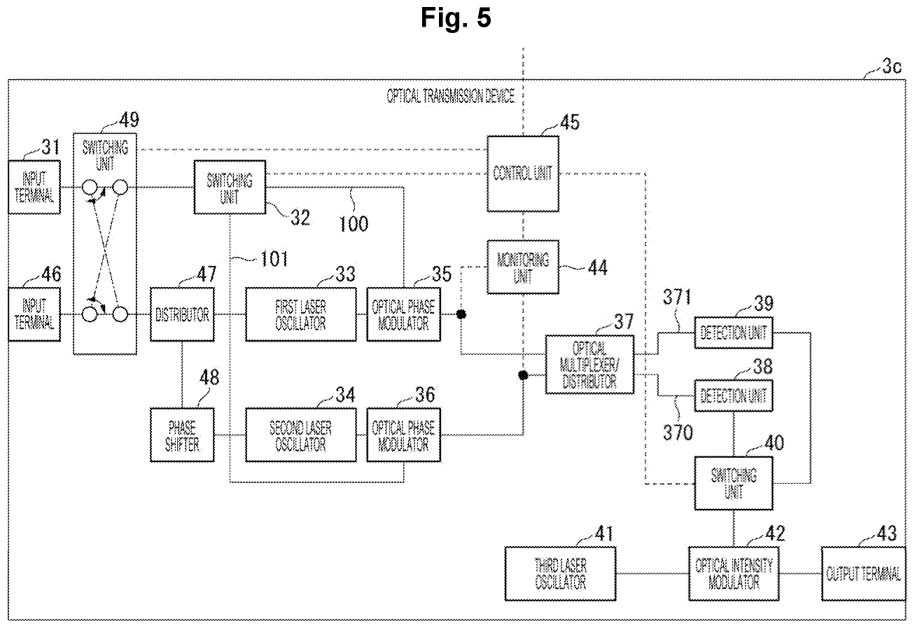

FIG. 5 is a diagram illustrating a configuration example of an optical transmission device 3c. The optical transmission device 3c corresponds to the optical transmission device 3 illustrated in FIG. 1. The optical transmission device 3c includes the input terminal 31, the switching unit 32, the first laser oscillator 33, the second laser oscillator 34, the optical phase modulator 35, the optical phase modulator 36, the optical multiplexer/distributor 37, the detection unit 38, the detection unit 39, the switching unit 40, the third laser oscillator 41, the optical intensity modulator 42, the output terminal 43, the monitoring unit 44, the control unit 45, the input terminal 46, the distributor 47, and the phase shifter 48. Furthermore, the optical transmission device 3c includes a switching unit 49.

As described above, compared with the signal system in the optical transmission device 10 illustrated in FIG. 13, the switching unit 32, the optical phase modulator 36, the detection unit 39, the switching unit 40, the input terminal 46, the distributor 47, the phase shifter 48, and the switching unit 49 are added to the signal system in the optical transmission device 3c.

The control unit 45 acquires, from a predetermined external device (not illustrated), priority order information indicating which signal system of the first electric signal and the second electric signal is made redundant. In a case where the priority order information indicates that the signal system of the first electric signal is made redundant, the control unit 45 outputs a control signal to the switching unit 49 such that the first electric signal input from the input terminal 31 is input to the switching unit 32. In addition, the control unit 45 outputs a control signal to the switching unit 49 such that the second electric signal input from the input terminal 46 is input to the distributor 47.

In a case where the priority order information indicates that the signal system of the second electric signal is made redundant, the control unit 45 outputs a control signal to the switching unit 49 such that the second electric signal input from the input terminal 46 is input to the switching unit 32. In addition, the control unit 45 outputs a control signal to the switching unit 49 such that the first electric signal input from the input terminal 31 is input to the distributor 47.

The switching unit 49 inputs one of the first electric signal and the second electric signal to the switching unit 32 under the control of the control unit 45. The switching unit 49 inputs the other of the first electric signal and the second electric signal to the distributor 47 under the control of the control unit 45. As described above, the switching unit 49 can input the first electric signal or the second electric signal to the redundant system.

In a case where the control signal indicates that the signal system of the first electric signal is made redundant, the switching unit 49 inputs the first electric signal input from the input terminal 31 to the switching unit 32. Further, the switching unit 49 inputs the second electric signal input from the input terminal 46 to the distributor 47.

In a case where the control signal indicates that the signal system of the second electric signal is made redundant, the switching unit 49 inputs the second electric signal input from the input terminal 46 to the switching unit 32. Further, the switching unit 49 inputs the first electric signal input from the input terminal 31 to the distributor 47.

As described above, the switching unit 49 inputs one of the first electric signal and the second electric signal to the switching unit 32 under the control of the control unit 45. The switching unit 49 inputs the other of the first electric signal and the second electric signal to the distributor 47 under the control of the control unit 45. The first laser oscillator 33 directly modulates the laser beam having a first oscillation frequency according to the electric signal (first electric signal) input to the input terminal 31 or the electric signal (second electric signal) input to the input terminal 46. The second laser oscillator 34 directly modulates the laser beam having a second oscillation frequency according to one of the phase-inverted first electric signal and the phase-inverted second electric signal.

As a result, it is possible to suppress an increase in the number of components and to make the signal system redundant. Further, which signal system of the first electric signal and the second electric signal is made redundant can be dynamically switched based on the priority order information.

### Second Embodiment

The second embodiment is different from the first embodiment in that a signal system from the input terminal to the optical intensity modulator is duplicated. In the second embodiment, differences from the first embodiment will be mainly described.

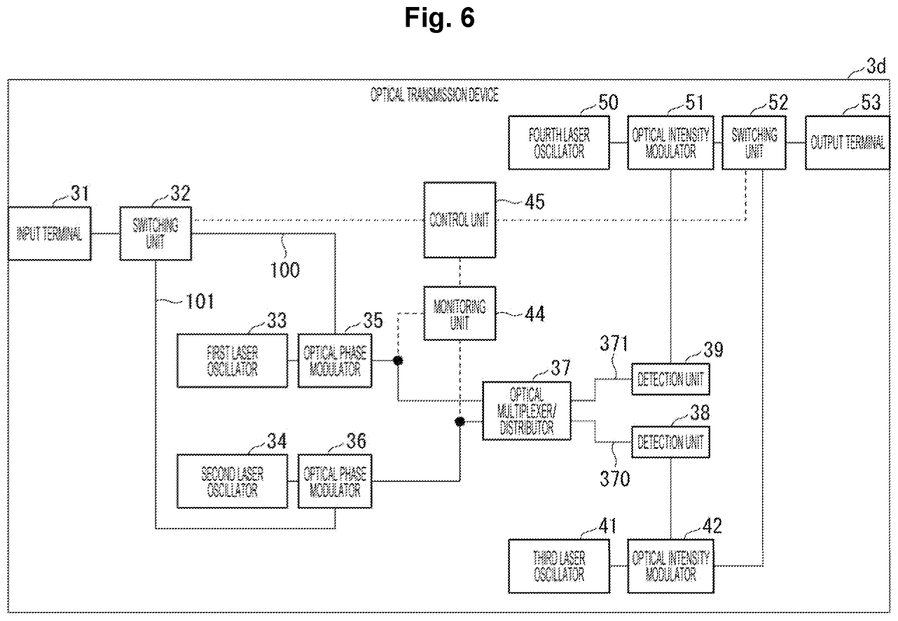

FIG. 6 is a diagram illustrating a configuration example of an optical transmission device 3d. The optical transmission device 3d corresponds to the optical transmission device 3 illustrated in FIG. 1. The optical transmission device 3d includes the input terminal 31, the switching unit 32, the first laser oscillator 33, the second laser oscillator 34, the optical phase modulator 35, the optical phase modulator 36, the optical multiplexer/distributor 37, the detection unit 38, the detection unit 39, the third laser oscillator 41, the optical intensity modulator 42, the monitoring unit 44, and the control unit 45. In addition, the optical transmission device 3d includes a fourth laser oscillator 50, an optical intensity modulator 51, a switching unit 52, and an output terminal 53.

As described above, compared with the signal system in the optical transmission device 10 illustrated in FIG. 13, the switching unit 32, the optical phase modulator 36, the detection unit 39, the switching unit 40, the fourth laser oscillator 50, the optical intensity modulator 51, and the switching unit 52 are added to the signal system in the optical transmission device 3d.

The third laser oscillator 41 outputs a laser beam having a third oscillation frequency to the optical intensity modulator 42 using a laser diode. The optical intensity modulator 42 intensity-modulates the laser beam having a third oscillation frequency according to the first heterodyne detection signal. The optical intensity modulator 42 outputs the intensity-modulated laser beam having a third oscillation frequency to the switching unit 52.

The fourth laser oscillator 50 outputs a laser beam having a fourth oscillation frequency to the optical intensity modulator 51 using a laser diode. The third oscillation frequency and the fourth oscillation frequency are, for example, the same frequency. The optical intensity modulator 51 intensity-modulates the laser beam having a fourth oscillation frequency according to the second heterodyne detection signal. The optical intensity modulator 51 outputs the intensity-modulated laser beam having a fourth oscillation frequency to the switching unit 52.

The switching unit 52 outputs one of the intensity-modulated laser beam having a third oscillation frequency and the intensity-modulated laser beam having a fourth oscillation frequency to the output terminal 53 according to the control signal acquired from the control unit 45. In a case where the control signal represents the laser beam having a third oscillation frequency, the switching unit 52 outputs the intensity-modulated laser beam having a third oscillation frequency to the output terminal 53. In a case where the control signal represents the laser beam having a fourth oscillation frequency, the switching unit 52 outputs the intensity-modulated laser beam having a fourth oscillation frequency to the output terminal 53.

In a case where the control signal represents the laser beam having a third oscillation frequency, the output terminal 53 outputs the intensity-modulated laser beam having a third oscillation frequency to the V-OLT 4 using the relay network 6. In a case where the control signal represents the laser beam having a fourth oscillation frequency, the output terminal 53 outputs the intensity-modulated laser beam having a fourth oscillation frequency to the V-OLT 4 using the relay network 6.

As described above, the optical intensity modulator 42 (first optical intensity modulator) intensity-modulates the laser beam having a third oscillation frequency according to the first heterodyne detection signal. The optical intensity modulator 51 (second optical intensity modulator) intensity-modulates the laser beam having a fourth oscillation frequency according to the second heterodyne detection signal. The switching unit 52 (second switching unit) outputs one of the intensity-modulated laser beam having a third oscillation frequency and the intensity-modulated laser beam having a fourth oscillation frequency to the output terminal 53.

As a result, it is possible to suppress an increase in the number of components and to make the signal system redundant. In the second embodiment, the signal system from the input terminal to the optical intensity modulator can be duplicated using the minimum necessary elements.

### First Modification Example of Second Embodiment

The first modification example of the second embodiment is different from the second embodiment in that the first electric signal and the second electric signal are input to the optical transmission device. In the first modification example of the second embodiment, differences from the second embodiment will be mainly described.

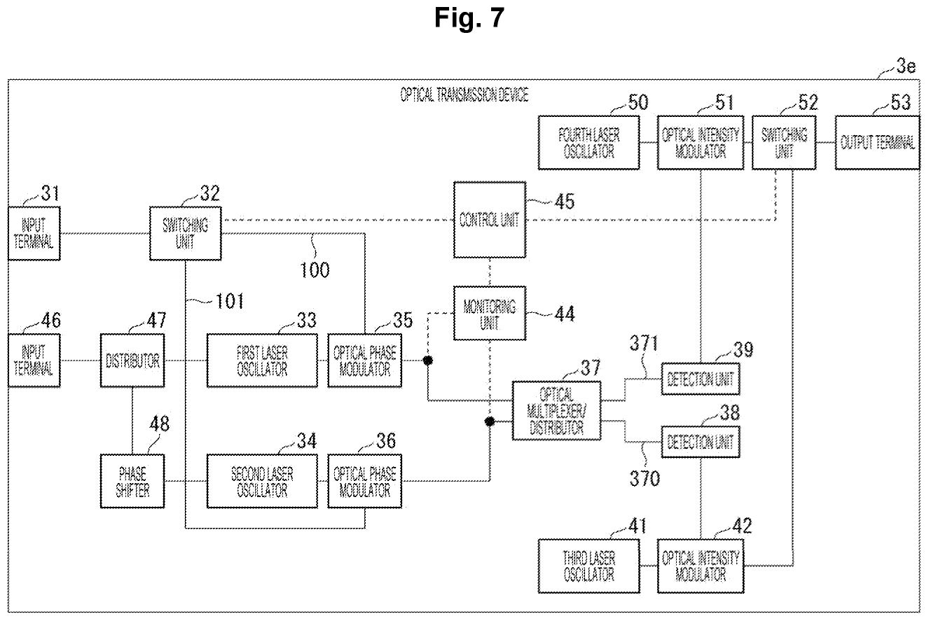

FIG. 7 is a diagram illustrating a configuration example of an optical transmission device 3e. The optical transmission device 3e corresponds to the optical transmission device 3 illustrated in FIG. 1. The optical transmission device 3e includes the input terminal 31, the switching unit 32, the first laser oscillator 33, the second laser oscillator 34, the optical phase modulator 35, the optical phase modulator 36, the optical multiplexer/distributor 37, the detection unit 38, the detection unit 39, the third laser oscillator 41, the optical intensity modulator 42, the output terminal 43, the monitoring unit 44, the control unit 45, the fourth laser oscillator 50, the optical intensity modulator 51, the switching unit 52, and the output terminal 53. In addition, the optical transmission device 3e includes the input terminal 46, the distributor 47, and the phase shifter 48.

As described above, compared with the signal system in the optical transmission device 10 illustrated in FIG. 13, the switching unit 32, the optical phase modulator 36, the detection unit 39, the switching unit 40, the input terminal 46, the distributor 47, the phase shifter 48, the fourth laser oscillator 50, the optical intensity modulator 51, and the switching unit 52 are added to the signal system in the optical transmission device 3e.

Each operation of the input terminal 31, the input terminal 46, the distributor 47, the phase shifter 48, the first laser oscillator 33, and the second laser oscillator 34 in the first modification example of the second embodiment is similar to each operation of the input terminal 31, the input terminal 46, the distributor 47, the phase shifter 48, the first laser oscillator 33, and the second laser oscillator 34 in the first modification example of the first embodiment.

As described above, the first laser oscillator 33 directly modulates the laser beam having a first oscillation frequency according to the electric signal (second electric signal) input to the input terminal 46. The first laser oscillator 33 outputs the directly modulated laser beam having a first oscillation frequency to the optical phase modulator 35 (first optical phase modulator). The second laser oscillator 34 directly modulates the laser beam having a second oscillation frequency according to the phase-inverted second electric signal. The second laser oscillator 34 outputs the directly modulated laser beam having a second oscillation frequency to the optical phase modulator 36 (second optical phase modulator).

As a result, it is possible to suppress an increase in the number of components and to make the signal system redundant. In addition, the first electric signal with higher priority than the second electric signal can be transmitted by the redundant signal system.

### Second Modification Example of Second Embodiment

The second modification example of the second embodiment is different from the first modification example of the second embodiment in that the transmission path of the first electric signal and the transmission path of the second electric signal can be interchanged. In the second modification example of the second embodiment, differences from the first modification example of the second embodiment will be mainly described.

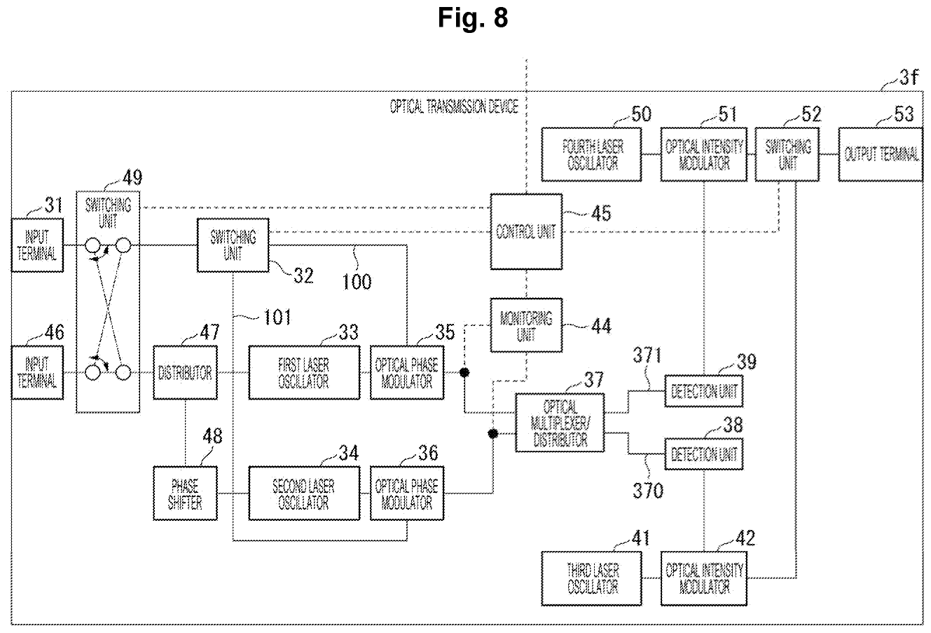

FIG. 8 is a diagram illustrating a configuration example of an optical transmission device 3f. The optical transmission device 3f corresponds to the optical transmission device 3 illustrated in FIG. 1. The optical transmission device 3f includes the input terminal 31, the switching unit 32, the first laser oscillator 33, the second laser oscillator 34, the optical phase modulator 35, the optical phase modulator 36, the optical multiplexer/distributor 37, the detection unit 38, the detection unit 39, the third laser oscillator 41, the optical intensity modulator 42, the output terminal 43, the monitoring unit 44, the control unit 45, the input terminal 46, the distributor 47, the phase shifter 48, the fourth laser oscillator 50, the optical intensity modulator 51, the switching unit 52, and the output terminal 53. Furthermore, the optical transmission device 3c includes a switching unit 49.

As described above, compared with the signal system in the optical transmission device 10 illustrated in FIG. 13, the switching unit 32, the optical phase modulator 36, the detection unit 39, the switching unit 40, the input terminal 46, the distributor 47, the phase shifter 48, the switching unit 49, the fourth laser oscillator 50, the optical intensity modulator 51, and the switching unit 52 are added to the signal system in the optical transmission device 3f.

Each operation of the control unit 45 and the switching unit 49 in the second modification example of the second embodiment is similar to each operation of the control unit 45 and the switching unit 49 in the second modification example of the first embodiment.

As described above, the switching unit 49 inputs one of the first electric signal and the second electric signal to the switching unit 32 under the control of the control unit 45. The switching unit 49 inputs the other of the first electric signal and the second electric signal to the distributor 47 under the control of the control unit 45. The first laser oscillator 33 directly modulates the laser beam having a first oscillation frequency according to the electric signal (first electric signal) input to the input terminal 31 or the electric signal (second electric signal) input to the input terminal 46. The second laser oscillator 34 directly modulates the laser beam having a second oscillation frequency according to one of the phase-inverted first electric signal and the phase-inverted second electric signal.

As a result, it is possible to suppress an increase in the number of components and to make the signal system redundant. Further, which signal system of the first electric signal and the second electric signal is made redundant can be dynamically switched based on the priority order information.

### Third Embodiment

The third embodiment is different from the second embodiment in that a signal system from the input terminal to the output terminal is duplicated. In the third embodiment, differences from the second embodiment will be mainly described.

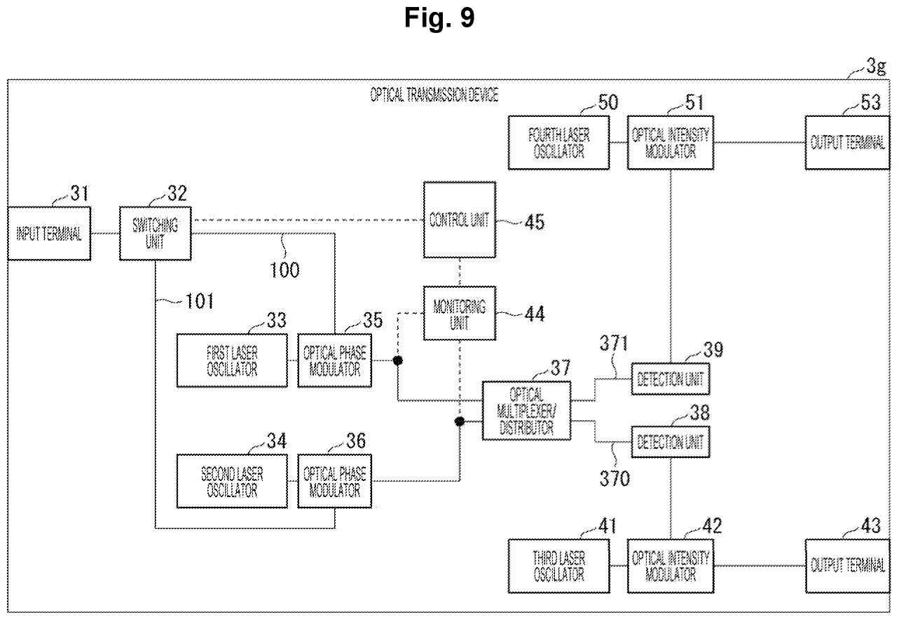

FIG. 9 is a diagram illustrating a configuration example of an optical transmission device 3g. The optical transmission device 3g corresponds to the optical transmission device 3 illustrated in FIG. 1. The optical transmission device 3g includes the input terminal 31, the switching unit 32, the first laser oscillator 33, the second laser oscillator 34, the optical phase modulator 35, the optical phase modulator 36, the optical multiplexer/distributor 37, the detection unit 38, the detection unit 39, the third laser oscillator 41, the optical intensity modulator 42, the output terminal 43, the monitoring unit 44, and the control unit 45. In addition, the optical transmission device 3g includes the fourth laser oscillator 50, the optical intensity modulator 51, and the output terminal 53.

As described above, compared with the signal system in the optical transmission device 10 illustrated in FIG. 13, the switching unit 32, the optical phase modulator 36, the detection unit 39, the switching unit 40, the fourth laser oscillator 50, the optical intensity modulator 51, and the output terminal 53 are added to the signal system in the optical transmission device 3g.

The third laser oscillator 41 outputs a laser beam having a third oscillation frequency to the optical intensity modulator 42 using a laser diode. The optical intensity modulator 42 intensity-modulates the laser beam having a third oscillation frequency according to the first heterodyne detection signal. The optical intensity modulator 42 outputs the intensity-modulated laser beam having a third oscillation frequency to the output terminal 43. The output terminal 43 outputs the intensity-modulated laser beam having a third oscillation frequency to the relay network 6.

The fourth laser oscillator 50 outputs a laser beam having a fourth oscillation frequency to the optical intensity modulator 51 using a laser diode. The optical intensity modulator 51 intensity-modulates the laser beam having a fourth oscillation frequency according to the second heterodyne detection signal. The optical intensity modulator 51 outputs the intensity-modulated laser beam having a fourth oscillation frequency to the output terminal 53. The output terminal 53 outputs the intensity-modulated laser beam having a fourth oscillation frequency to the relay network 6.

As described above, the optical intensity modulator 42 (first optical intensity modulator) intensity-modulates the laser beam having a third oscillation frequency according to the first heterodyne detection signal. The output terminal 43 outputs the intensity-modulated laser beam having a third oscillation frequency to the relay network 6. The optical intensity modulator 51 (second optical intensity modulator) intensity-modulates the laser beam having a fourth oscillation frequency according to the second heterodyne detection signal. The output terminal 53 outputs the intensity-modulated laser beam having a fourth oscillation frequency to the relay network 6.

As a result, it is possible to suppress an increase in the number of components and to make the signal system redundant. In the third embodiment, the signal system from the input terminal to the output terminal can be duplicated using the minimum necessary elements.

### First Modification Example of Third Embodiment

The first modification example of the third embodiment is different from the third embodiment in that the first electric signal and the second electric signal are input to the optical transmission device. In the first modification example of the third embodiment, differences from the third embodiment will be mainly described.

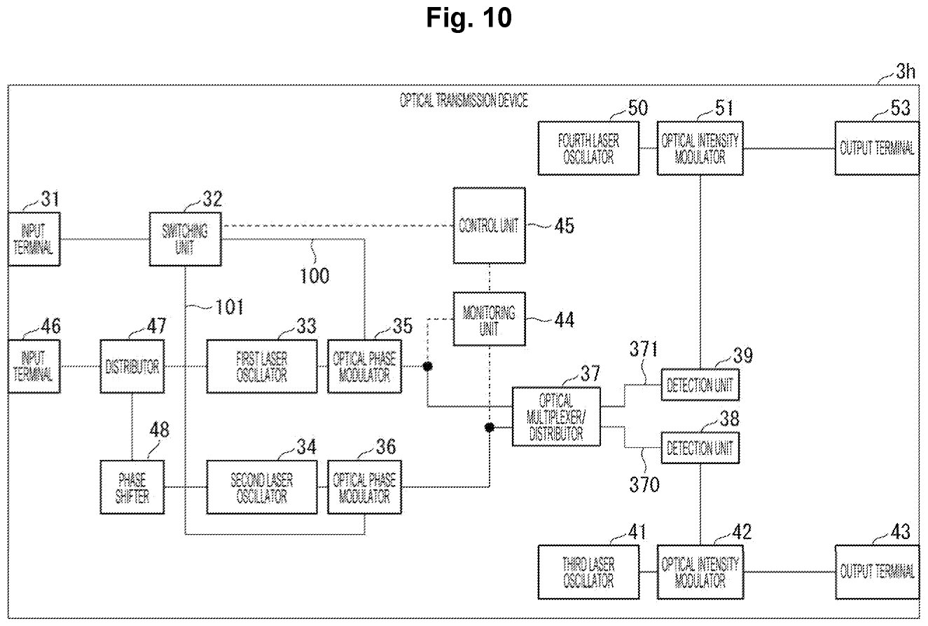

FIG. 10 is a diagram illustrating a configuration example of an optical transmission device 3h. The optical transmission device 3h corresponds to the optical transmission device 3 illustrated in FIG. 1. The optical transmission device 3h includes the input terminal 31, the switching unit 32, the first laser oscillator 33, the second laser oscillator 34, the optical phase modulator 35, the optical phase modulator 36, the optical multiplexer/distributor 37, the detection unit 38, the detection unit 39, the third laser oscillator 41, the optical intensity modulator 42, the output terminal 43, the monitoring unit 44, the control unit 45, the fourth laser oscillator 50, the optical intensity modulator 51, and the output terminal 53. In addition, the optical transmission device 3h includes the input terminal 46, the distributor 47, and the phase shifter 48.

As described above, compared with the signal system in the optical transmission device 10 illustrated in FIG. 13, the switching unit 32, the optical phase modulator 36, the detection unit 39, the switching unit 40, the input terminal 46, the distributor 47, the phase shifter 48, the fourth laser oscillator 50, the optical intensity modulator 51, and the output terminal 53 are added to the signal system in the optical transmission device 3h.

Each operation of the input terminal 31, the input terminal 46, the distributor 47, the phase shifter 48, the first laser oscillator 33, and the second laser oscillator 34 in the first modification example of the third embodiment is similar to each operation of the input terminal 31, the input terminal 46, the distributor 47, the phase shifter 48, the first laser oscillator 33, and the second laser oscillator 34 in the first modification example of the first embodiment.

As described above, the first laser oscillator 33 directly modulates the laser beam having a first oscillation frequency according to the electric signal (second electric signal) input to the input terminal 46. The first laser oscillator 33 outputs the directly modulated laser beam having a first oscillation frequency to the optical phase modulator 35 (first optical phase modulator). The second laser oscillator 34 directly modulates the laser beam having a second oscillation frequency according to the phase-inverted second electric signal. The second laser oscillator 34 outputs the directly modulated laser beam having a second oscillation frequency to the optical phase modulator 36 (second optical phase modulator).

As a result, it is possible to suppress an increase in the number of components and to make the signal system redundant. In addition, the first electric signal with higher priority than the second electric signal can be transmitted by the redundant signal system.

### Second Modification Example of Third Embodiment

The second modification example of the third embodiment is different from the first modification example of the third embodiment in that the transmission path of the first electric signal and the transmission path of the second electric signal can be interchanged. In the second modification example of the third embodiment, differences from the first modification example of the third embodiment will be mainly described.

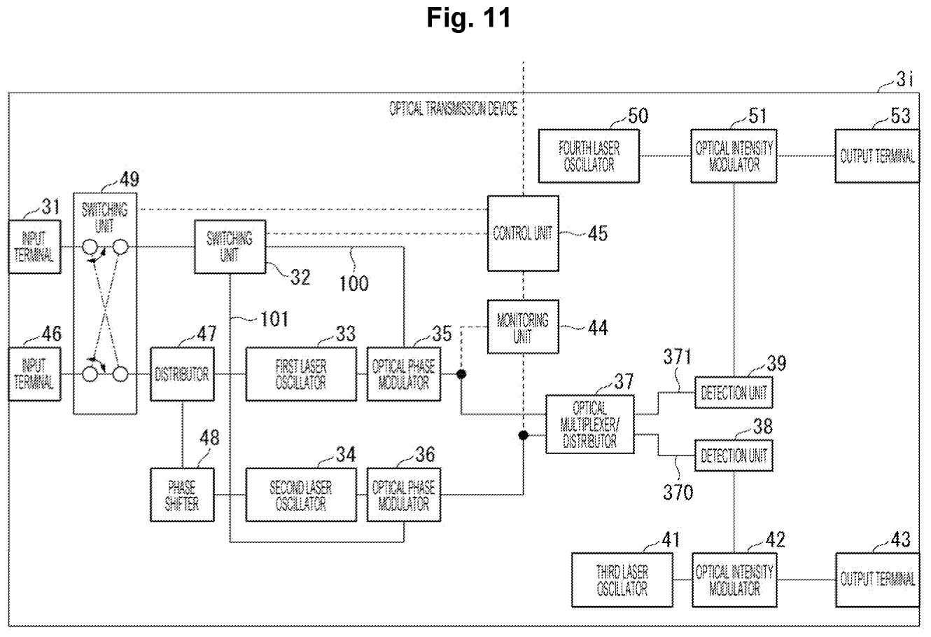

FIG. 11 is a diagram illustrating a configuration example of an optical transmission device 3i. The optical transmission device 3i corresponds to the optical transmission device 3 illustrated in FIG. 1. The optical transmission device 3i includes the input terminal 31, the switching unit 32, the first laser oscillator 33, the second laser oscillator 34, the optical phase modulator 35, the optical phase modulator 36, the optical multiplexer/distributor 37, the detection unit 38, the detection unit 39, the third laser oscillator 41, the optical intensity modulator 42, the output terminal 43, the monitoring unit 44, the control unit 45, the input terminal 46, the distributor 47, the phase shifter 48, the fourth laser oscillator 50, the optical intensity modulator 51, and the output terminal 53. Furthermore, the optical transmission device 3c includes a switching unit 49.

As described above, compared with the signal system in the optical transmission device 10 illustrated in FIG. 13, the switching unit 32, the optical phase modulator 36, the detection unit 39, the switching unit 40, the input terminal 46, the distributor 47, the phase shifter 48, the switching unit 49, the fourth laser oscillator 50, the optical intensity modulator 51, and the output terminal 53 are added to the signal system in the optical transmission device 3i.

Each operation of the control unit 45 and the switching unit 49 in the second modification example of the third embodiment is similar to each operation of the control unit 45 and the switching unit 49 in the second modification example of the first embodiment.

As described above, the switching unit 49 inputs one of the first electric signal and the second electric signal to the switching unit 32 under the control of the control unit 45. The switching unit 49 inputs the other of the first electric signal and the second electric signal to the distributor 47 under the control of the control unit 45. The first laser oscillator 33 directly modulates the laser beam having a first oscillation frequency according to the electric signal (first electric signal) input to the input terminal 31 or the electric signal (second electric signal) input to the input terminal 46. The second laser oscillator 34 directly modulates the laser beam having a second oscillation frequency according to one of the phase-inverted first electric signal and the phase-inverted second electric signal.

As a result, it is possible to suppress an increase in the number of components and to make the signal system redundant. Further, which signal system of the first electric signal and the second electric signal is made redundant can be dynamically switched based on the priority order information.

(Hardware Configuration Example)

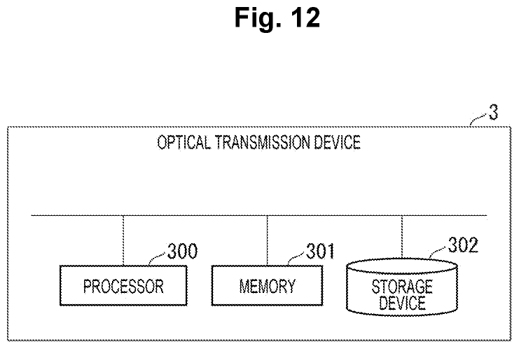

FIG. 12 is a diagram illustrating a hardware configuration example of the optical transmission device 3 according to each embodiment. Some or all of the functional units of the optical transmission device 3 are realized as software by causing a processor 300 such as a central processing unit (CPU) to execute a program stored in a storage device 302 including a non-volatile recording medium (non-transitory recording medium) and a memory 301. The program may be recorded on a computer-readable recording medium. The computer-readable recording medium is, for example, a portable medium such as a flexible disk, a magneto-optical disc, a read-only memory (ROM), or a compact disc read-only memory (CD-ROM), or a non-transitory recording medium such as a storage device such as a hard disk built in a computer system.

Some or all of the functional units of the optical transmission device 3 may be realized using hardware including an electronic circuit (electronic circuit or circuitry) in which, for example, a large scale integrated circuit (LSI), an application specific integrated circuit (ASIC), a programmable logic device (PLD), a field programmable gate array (FPGA), or the like is used.

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention is applicable to a video distribution system.

### REFERENCE SIGNS LIST

1 FTTH CATV system
2 Head end device
3, 3a, 3b, 3c, 3d, 3e, 3f, 3g, 3h, 3i Optical transmission device
4 V-OLT
5 V-ONU
6 Relay network
7 Access network
10 Optical transmission device
11 Input terminal
12 First laser oscillator
13 Second laser oscillator
14 Optical phase modulator
15 Optical multiplexer/distributor
16 Detection unit
17 Third laser oscillator
18 Optical intensity modulator
19 Output terminal
20 Switching Unit
31 Input terminal
32 Switching Unit
33 First laser oscillator
34 Second laser oscillator
35 Optical phase modulator
36 Optical phase modulator
37 Optical multiplexer/distributor
38 Detection unit
39 Detection unit
40 Switching Unit
41 Third laser oscillator
42 Optical intensity modulator
43 Output terminal
44 Monitoring unit
45 Control unit
46 Input terminal
47 Distributor
48 Phase shifter
49 Switching Unit
50 Fourth laser oscillator
51 Optical intensity modulator
52 Switching Unit
53 Output terminal
100 First transmission path
101 Second transmission path
300 Processor
301 Memory
302 Storage device
370 First output port
371 Second output port

1. An optical transmission device comprising:
a first laser oscillator that outputs a laser beam having a first oscillation frequency;
a second laser oscillator that outputs a laser beam having a second oscillation frequency;
a first switching unit that outputs a first electric signal to one of a first transmission path and a second transmission path;
a first optical phase modulator that outputs a first optical signal by phase-modulating the laser beam having a first oscillation frequency according to the first electric signal in a case where the first electric signal is output to the first transmission path, and outputs the laser beam having a first oscillation frequency as the first optical signal in a case where the first electric signal is output to the second transmission path;
a second optical phase modulator that outputs a second optical signal by phase-modulating the laser beam having a second oscillation frequency according to the first electric signal in a case where the first electric signal is output to the second transmission path, and outputs the laser beam having a second oscillation frequency as the second optical signal in a case where the first electric signal is output to the first transmission path;
an optical multiplexer/distributor that outputs a third optical signal and a fourth optical signal by multiplexing the first optical signal and the second optical signal and distributing a result of the multiplexing;
a first detection unit that converts the third optical signal into a first heterodyne detection signal;
a second detection unit that converts the fourth optical signal into a second heterodyne detection signal; and
a first optical intensity modulator that intensity-modulates a laser beam having a third oscillation frequency according to one of the first heterodyne detection signal and the second heterodyne detection signal.

2. The optical transmission device according to claim 1, further comprising:
a second optical intensity modulator that intensity-modulates a laser beam having a fourth oscillation frequency according to the second heterodyne detection signal, wherein
the first optical intensity modulator intensity-modulates the laser beam having a third oscillation frequency according to the first heterodyne detection signal.

3. The optical transmission device according to claim 2, further comprising:
a second switching unit that outputs one of the intensity-modulated laser beam having a third oscillation frequency and the intensity-modulated laser beam having a fourth oscillation frequency.

4. The optical transmission device according to claim 1, wherein
the first laser oscillator directly modulates the laser beam having a first oscillation frequency according to the first electric signal or the second electric signal, and outputs the directly modulated laser beam having a first oscillation frequency to the first optical phase modulator, and
the second laser oscillator directly modulates the laser beam having a second oscillation frequency according to the first electric signal or the second electric signal of which a phase is inverted, and outputs the directly modulated laser beam having a second oscillation frequency to the second optical phase modulator.

5. The optical transmission device according to claim 4, wherein
the first laser oscillator directly modulates the laser beam having a first oscillation frequency according to the second electric signal in a case where the first switching unit outputs the first electric signal to the first transmission path, and directly modulates the laser beam having a first oscillation frequency according to the first electric signal in a case where the first switching unit outputs the second electric signal to the second transmission path, and
the second laser oscillator directly modulates the laser beam having a first oscillation frequency according to the phase-determined second electric signal in a case where the first switching unit outputs a first electric signal to the first transmission path, and directly modulates the laser beam having a first oscillation frequency according to the phase-determined first electric signal in a case where the first switching unit outputs the second electric signal to the second transmission path.

6. An optical transmission method executed by an optical transmission device, the method comprising:
a first laser oscillation step of outputting a laser beam having a first oscillation frequency;
a second laser oscillation step of outputting a laser beam having a second oscillation frequency;
a first switching step of outputting a first electric signal to one of a first transmission path and a second transmission path;
a first optical phase modulation step of outputting a first optical signal by phase-modulating the laser beam having a first oscillation frequency according to the first electric signal in a case where the first electric signal is output to the first transmission path, and outputting the laser beam having a first oscillation frequency as the first optical signal in a case where the first electric signal is output to the second transmission path;
a second optical phase modulation step of outputting a second optical signal by phase-modulating the laser beam having a second oscillation frequency according to the first electric signal in a case where the first electric signal is output to the second transmission path, and outputting the laser beam having a second oscillation frequency as the second optical signal in a case where the first electric signal is output to the first transmission path;
an optical multiplexing/distributing step of outputting a third optical signal and a fourth optical signal by multiplexing the first optical signal and the second optical signal and distributing a result of the multiplexing;
a first detection step of converting the third optical signal into a first heterodyne detection signal;
a second detection step of converting the fourth optical signal into a second heterodyne detection signal; and
a first optical intensity modulation step of intensity-modulating a laser beam having a third oscillation frequency according to one of the first heterodyne detection signal and the second heterodyne detection signal.
